(19) United States
(12) Patent Application Publication
(10) Pub. No.: US 2025/0368280 A1
(43) Pub. Date: Dec. 4, 2025

(54) HORIZONTAL DRIVING POSITION TRACKED VEHICLE

(71) Applicant: Hailey Shaffett, Golden, CO (US)

(72) Inventor: Hailey Shaffett, Golden, CO (US)

(21) Appl. No.: 18/732,893

(22) Filed: Jun. 4, 2024

(51) Int. Cl. B62D 51/00; B62D 11/12; B62J 1/00

(52) U.S. Cl. CPC B62D 51/007; B62D 11/12; B62J 1/007

(57) ABSTRACT

Disclosed is a personal tracked vehicle comprising a platform mounted on top of a housing, the platform having central body, front flat members and rear flat members and a central axis. The platform is pivotally mounted to housing along the axis and pivotally movable between a first position and a second position. A pair of parallel right and left tracks is mounted to the housing below the platform, the right track being coupled to a right track drive and the left track being coupled to a left track drive. The track drives are operatively coupled to the platform such that when the platform is pivoted towards its first position, the left track is driven faster and the right track is driven slower, and when the platform is pivoted towards its second position, the right track is driven faster and the left track is driven slower.

### FIELD OF THE INVENTION

The present invention relates to a personal tracked vehicles and more particularly relates to horizontal driving position tracked vehicle.

### BACKGROUND OF THE INVENTION

Existing personal tracked vehicles are mostly of the standing type which has several drawbacks in case of stability, comfortableness and user experience. Standing on a tracked vehicle is be less stable, especially at higher speeds or on uneven landscape, which apparently increases the risk of accidents or falls, particularly for inexperienced users. Prolonged standing may lead to fatigue and discomfort in the legs and feet. Thus, the user may not have the ability to operate the vehicle comfortably over long distances and long durations.

Further, standing for prolonged periods may be less comfortable than sitting or lying, especially on rough or bumpy terrain, thus resulting in reduced overall user experience and limits the vehicle's usability for longer trips or outings. Operating a standing hand-operated tracked vehicle requires a certain level of skill and balance, especially when navigating challenging terrain or obstacles. This can present a learning curve for new users and may limit the accessibility of the vehicle to certain individuals.

Therefore, there is a need for a personal tracked vehicle that can be operated by lying down or seating over the vehicle body while overcoming all the above drawbacks.

### BRIEF SUMMARY OF THE INVENTION

It is an object of the present invention to provide a personal tracked vehicle that can be operated by a user lying down horizontally or seating over the vehicle body.

It is another object of the present invention to provide a personal tracked vehicle that operates by shifting the user's body weight side to side to turn the vehicle.

It is a further object of the present invention to provide a personal tracked vehicle that allows a user to ride in lying down position while having entertaining and useful steering experience.

In accordance with an embodiment, a personal tracked vehicle is disclosed. The vehicle comprises a platform mounted on top of a housing, the platform having central body, at least two front flat members and at least two rear flat members laterally extending from a front side and a rear side of central body, respectively, and a central axis, the platform being pivotally mounted to the housing along the axis and pivotally movable between a first position wherein the right side of the platform is below the left side of the platform and a second position wherein the left side of the platform is below the right side of the platform. A pair of parallel right and left tracks is mounted to the housing below the platform, the right track being coupled to a right track drive and the left track being coupled to a left track drive, the right and left track drives being operatively coupled to the platform such that when the platform is pivoted towards its first position, the left track is driven faster and the right track is driven slower, and when the platform is pivoted towards its second position, the right track is driven faster and the left track is driven slower, the platform being biased towards a central position wherein the left and right drives operate at the same speed.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a perspective view of a personal tracked vehicle made in accordance with the present invention.

FIG. 2 is a top plan view of the vehicle shown in FIG. 1.

FIG. 3 is a side view of the vehicle shown in FIG. 1.

FIG. 4 is a side view of the vehicle shown in FIG. 1 with part of the housing removed to show details of the interior of the vehicle.

FIG. 5 is a top view of the track drive mechanisms of the vehicle shown in FIG. 1.

FIG. 6 is a side view of the vehicle showing the handle portion.

FIG. 7 is a perspective view of the vehicle of FIG. 1 while being operated by a rider.

### DETAILED DESCRIPTION OF THE INVENTION

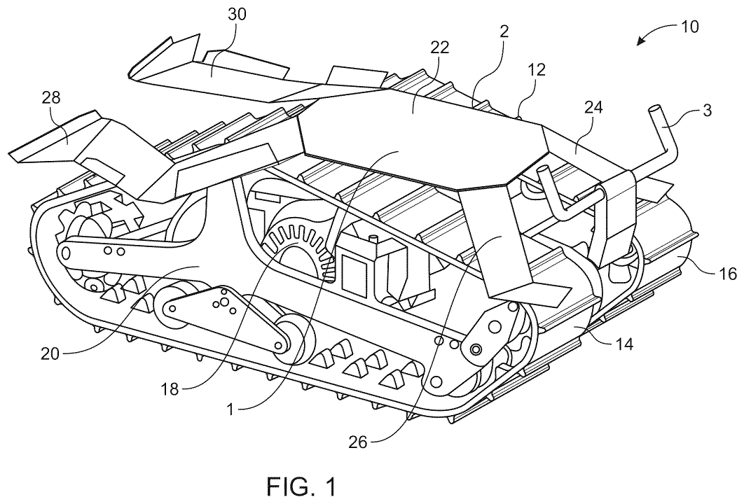

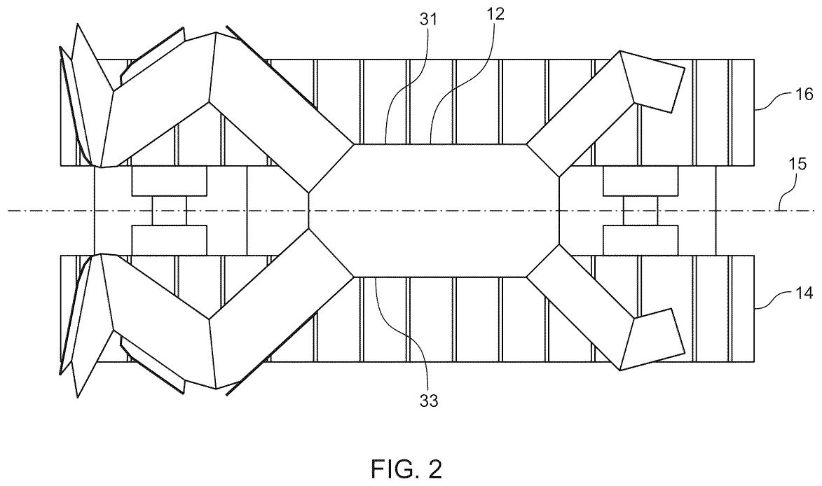

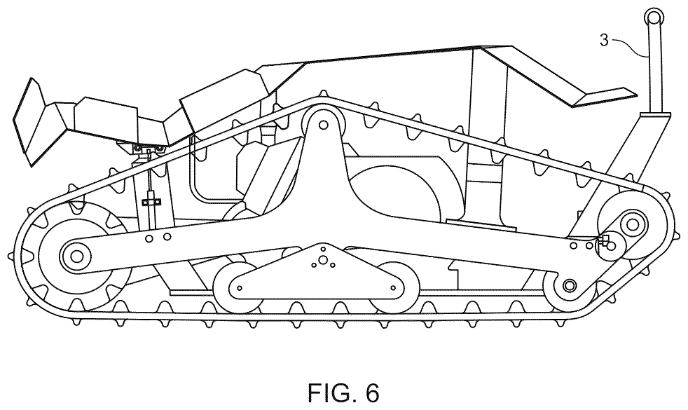

Referring to FIG. 1, a vehicle made in accordance with the present invention, shown generally as item 10, consists of a platform 12, a pair of caterpillar type tracks 14 and 16, and a drive motor 18 mounted to a housing 20. Platform 12 has central body 22, at least two front flat members 24, 26 and at least two rear flat members 28, 30 laterally extending from a front side and a rear side of central body, respectively. Throttle control (not shown) is coupled to vehicle 10 by cable (not shown) and is used to control motor 18. Motor 18, right track 14 and left track 16 are mounted to housing 20 such that the motor is positioned between the tracks 14, 16 and substantially in the center of the vehicle 10. Tracks 14 and 16 are preferably made of a fiber reinforced polymer material such as rubber. As better seen in FIG. 2, tracks 14 and 16 are quite wide and extend beyond the width of platform 12 to ensure that the vehicle has a very wide and stable body rest for the resting of the hands and legs of a user. Platform 12 has right side edge 33, left side edge 31 and long axis 15. The vehicle 10 may also be provided with a handle (see item 3 in FIGS. 1 and 6) upon which throttle controls may be placed.

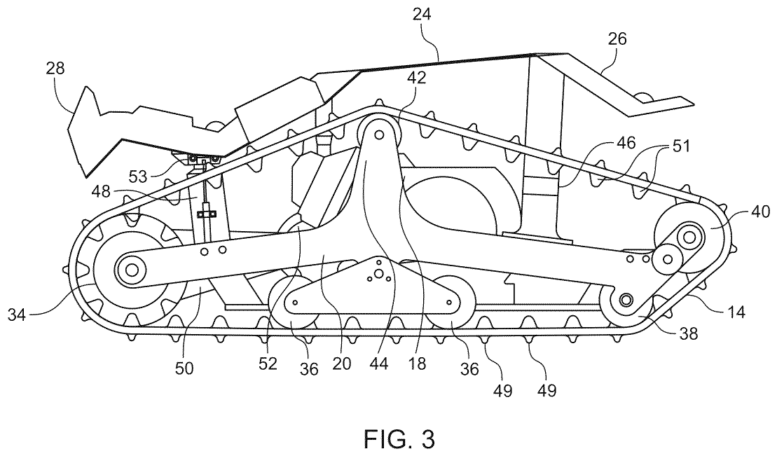

Referring to FIG. 3, the tracks of the vehicle will now be discussed with reference to the right side of the vehicle upon which right track 14 is mounted. It will be appreciated that all of the features shown on the right side of the vehicle have their mirror image equivalents on the left side of the vehicle. Track 14 is driven by a right track drive which includes drive wheel 34 which is in turn driven by chain 50 which is coupled to transmission 52 which is in turn coupled to motor 18. Track 14 is looped around roller wheels 36, 38, 40 and 42 as well as drive wheel 34. Roller 42 is mounted to housing extension 44 which enables track 14 to pass over motor 18. Track 14 is a standard flexible track of the type used for snow mobiles and the like and is provided with a plurality of traction elements 49 and aligning members 51. Rollers 36, 38, 40 and 42 are standard track rollers configured to receive aligning members 51 so as to ensure that the track does not accidentally dislodge from the rollers 42.

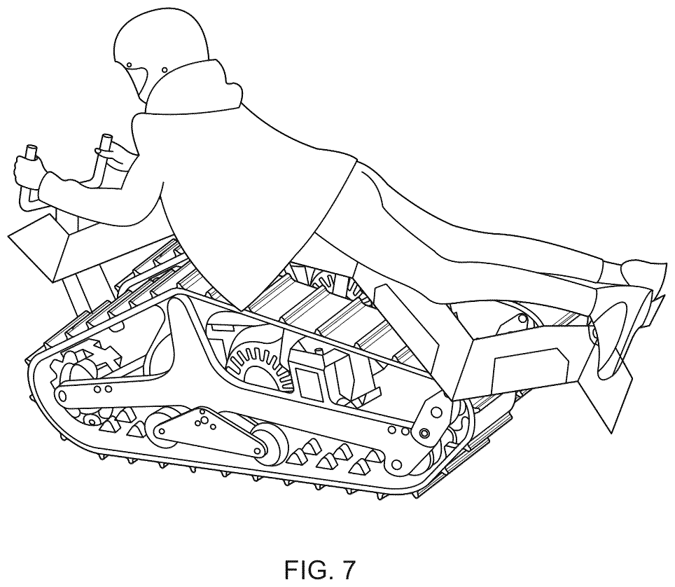

Referring to FIGS. 1 and 3, as mentioned above, platform 12 has at least two front flat members 24, 26 and at least two rear flat members 28, 30 laterally extending from the front side and the rear side of the central body 22, respectively. The at least two front flat members 24, 26 are configured at a left corner section and a right corner section of the front side of the central body 22, wherein the at least two flat members 24, 26 extending laterally from the central body 22. The at least two rear flat members 28, 30 are configured at a left corner section and a right corner section of the rear side of the central body 22, wherein the at least two flat members 28, 30 are extending laterally from the central body 22. The front flat members 24, 26 and the rear flat members 28, 30 act as hand resting parts and leg resting parts, respectively, allowing the user to lay their front side (chest side) of the body over the central body 22 and place their left and right hands (not shown) on 24, 26, respectively and left and right legs (not shown) on 28, 30 when the user mounts the vehicle 10. FIG. 7 depicts a user in driving position while lying over the vehicle horizontally according to an embodiment of the present invention. Central body 22 is positioned above the track 14 and 16 with sufficient space between the central body 22 and the track 14 and 16 such that it provides room for motor 18. Motor 18 is centrally mounted on the housing 20 such that motor 18 is below central body 22 and between the tracks 14, 16. Platform 12 is mounted to housing 20 by front support strut 46 and rear support strut 48 via pivoting connectors 7 and 53. Pivoting connectors permit platform 12 to be selectively tilted between a first position wherein the right side of the platform is below the left side of the platform and a second position wherein the left side of the platform is lower than the right side of the platform. In one embodiment, the platform 12 tilts between the first position and the second position according to the body weight being applied on to a right side 1 of the platform and a left side 2 of the platform 12, respectively, while creating a useful steering experience. Connectors 7 and 53 are spring biased such that the platform is biased towards a horizontal position where both right and left sides 1, 2 of the platform 12 are equal distant to the housing 20.

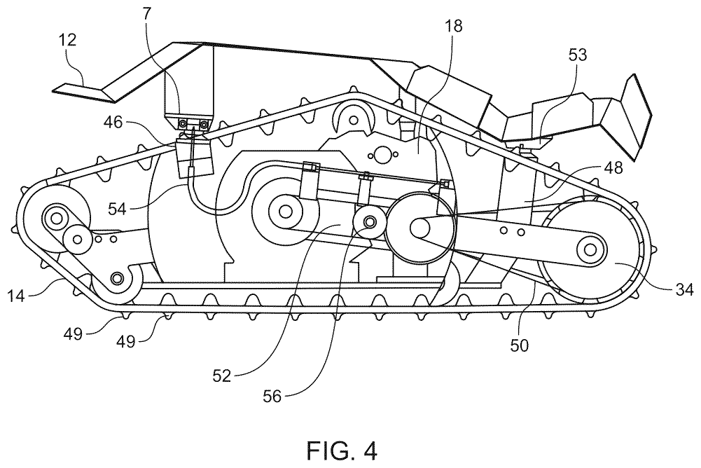

Referring now to FIG. 4, track 14 is driven by a drive mechanism consisting of drive wheel 34, chain 50, and transmission 52 which is in turn powered by motor 18. Transmission 52 is configured to drive both the left and right tracks. Transmission 52 is capable of steering the vehicle by selectively driving one track faster than the other. As will be further explained below, transmission 52 comprises a pair of continuously variable transmissions, one for each track, which can be selectively activated to drive the tracks at the same speed or with one track faster than the other. Transmission 52 is selectively operatable between a left drive bias mode, wherein the left track is driven faster than the right track, and a right drive bias mode, wherein the right track is driven faster than the left track. Differential 56 selectively operates transmission 52 between its left and right biased modes by moving between a first and second position, respectively. Differential 52 is coupled to platform 12 via tension cable 54. Cable 54 moves in response to the tilting of platform 12 which in turn moves differential 56 between its first and second position, which in turn operates the transmission between its left bias and right bias modes such that when the platform tilts to the right, the transmission is operated towards its left drive bias and when the platform is tilted to the left, the transmission is operated towards its right drive bias. Preferably cable 54 is spring biased to ensure that it is always under tension to ensure that the tilting motion of platform 12 is accurately translated into the shifting between right and left drive biases.

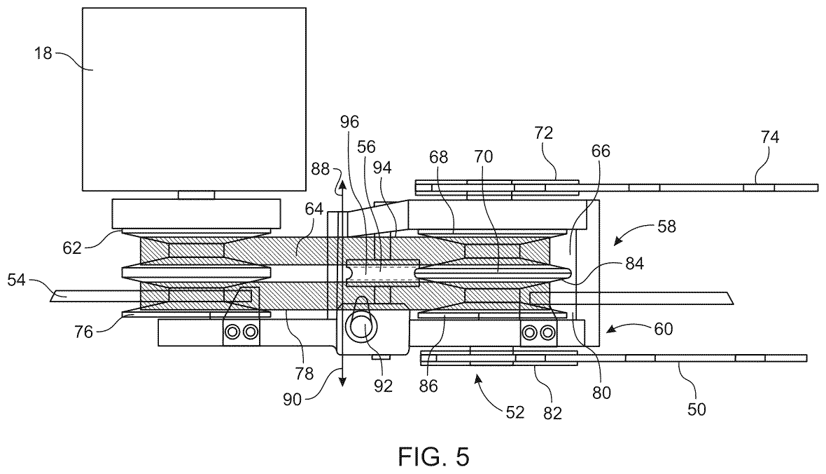

Referring now to FIG. 5, transmission 52 consists of two parallel continuously variable transmissions 58 and 60 corresponding to the right track drive and the left track drive, respectively. Right track drive 58 consists of pulley 62, belt 64, pulley 66, cog 72 and drive chain 74. Pulley 66 is a variable diameter pulley consisting of opposing cones 68 and 70. Bringing cones 68 and 70 together has the effect of increasing the effective diameter of the pulley. Pulley 62 is coupled to motor 18 and pulley 66 is coupled to cog 72. Increasing the diameter of pulley 66 has the effect of slowing down the pulley which in turn slows down cog 72 and drive chain 74, which in turn slows down the right track. Left track drive 60 consists of pulley 76, belt 78, variable diameter pulley 80, cog 82 and drive chain 50. Variable diameter pulley is analogous to pulley 66 and includes opposed cones 84 and 86. Pulleys 80 and 66 are coaxially aligned and adjacent one another such that cones 70 and 84 are adjacent one another. Both cones 70 and 84 are physically coupled to differential 56. Differential 56 consists of a gear like member 96 which is has a groove which is dimensioned to engage both cones 70 and 84 simultaneously. Member 96 is rotatably mounted to shaft 94 which is coupled to cam 92 and is movable between a first position in the direction of arrow 88 and a second position in the direction of arrow 90. Cam 92 is in turn coupled to cable 54. Moving cable 54 causes cam 92 to move which in turn moves member 96 in either direction 88 or direction 90. When member 96 is moved in direction 88, the diameter of pulley 66 increases and the diameter of pulley 80 decreases which in turn causes drive chain 74 to slow down and drive chain 50 to speed up, corresponding to a left drive bias. When member 96 is moved in direction 90, the diameter of pulley 66 decreases and the diameter of pulley increases which in turn causes drive chain 74 to speed up and drive chain 50 to slow down, corresponding to a right drive bias. Hence, the transmission and differential can be selectively operated between a left and right drive bias simply by moving cable 54.

The present invention has several advantages over the prior art. Firstly, the laid down driving position of the user over the platform 12 permit the user to precisely control tilting of platform 12 by steadily shifting the body weight between both left and right sides, which in turn increases the lower center of gravity resulting in stabilized driving and creating an entertaining and useful steering experience. Also, the positioning of the motor, gas tank, transmission and other components between the tracks and below the board permits the unit to have a lower center of gravity, permitting a more stable ride. The use of continuously variable transmissions permits the user to smoothly steer the vehicle. Finally, by coupling the transmissions to the tilting platform 12 permits the user to operate and steer the vehicle using vary natural movements. By tilting the board to the right or left by shifting the user's body weight, the vehicle can execute sharper turns with less likelihood of the user falling off the vehicle.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A vehicle comprising:
a housing;
a platform mounted on top of the housing, the platform having central body, at least two front flat members and at least two rear flat members laterally extending from a front side and a rear side of central body, respectively, and a central axis, the platform being pivotally mounted to the housing along the axis and pivotally movable between a first position wherein the right side of the platform is below the left side of the platform and a second position wherein the left side of the platform is below the right side of the platform; and
a pair of parallel right and left tracks mounted to the housing below the platform, the right track being coupled to a right track drive and the left track being coupled to a left track drive, the right and left track drives being operatively coupled to the platform such that when the platform is pivoted towards its first position, the left track is driven faster and the right track is driven slower, and when the platform is pivoted towards its second position, the right track is driven faster and the left track is driven slower, the platform being biased towards a central position wherein the left and right drives operate at the same speed.

2. The vehicle of claim 1, wherein the right and left track drives are coupled to a single motor, the motor being mounted to the housing below the platform and between the tracks.

3. The vehicle of claim 2, wherein the platform is mounted on the housing by front and rear support struts, the front and rear support struts being pivotally mounted to the platform along the axis of the platform.

4. The vehicle of claim 1, wherein the at least two front flat members are configured at a left corner section and a right corner section of the front side of the central body, the at least two flat members extending laterally from the central body, and the at least two rear flat members are configured at a left corner section and a right corner section of the rear side of the central body, the at least two flat members extending laterally from the central body.

5. The vehicle of claim 4, wherein the forward support strut is mounted to the platform at a point on the platform in between the flat members at the front side and wherein the rearward support strut is mounted to the platform at a point on the platform in between the flat members at the read side.

6. The vehicle of claim 2, wherein right track drive means and the left track drive means each comprise continuously variable transmissions, the continuously variable transmissions being coupled to a differential, the differential selectively operative between a right drive bias wherein the right drive means is driven faster than the left drive means and a left drive bias wherein the left drive means is driven faster than the right drive means, the differential being operatively coupled to the platform such that when the platform is moved towards its first position, the differential is operated towards its left drive bias and when the platform is moved towards its second position, the differential is operated towards its right drive bias.

7. The vehicle of claim 6, wherein the right and left continuously variable transmissions comprise first and second pulleys, respectively, the first and second pulleys having selectively variable diameters, the relative diameters of the first and second pulleys being selected by the differential.

8. The vehicle of claim 7, wherein the first and second pulleys comprise a first and second pair of opposing cones, respectively, the first and second pulleys being coaxially aligned and adjacent to one another such that one cone of each pulley are adjacent, and wherein the differential comprises a member physically coupled to said one cone of each pulley, the differential being selectively movable between a first and second position corresponding to the differential's left and right biases, respectively.

9. The vehicle of claim 8, wherein the member is coupled to the platform by a cable, the cable moving the member between the member's first and second position in response to the movement of the platform between the platform's first and second positions, respectively.
